(19) United States
(12) Patent Application Publication
(10) Pub. No.: US 2015/0209239 A1
(43) Pub. Date: Jul. 30, 2015

(54) NASOGASTRIC TUBE

(71) Applicant: Chris Salvino, Scottsdale, AZ (US)

(72) Inventor: Chris Salvino, Scottsdale, AZ (US)

(21) Appl. No.: 14/422,105

(22) PCT Filed: Aug. 19, 2013
(86) PCT No.: PCT/US2013/055554

§ 371 Date: Feb. 17, 2015

Related U.S. Application Data
(60) Provisional application No. 61/684,363, filed on Aug. 17, 2012.

(51) Int. Cl. A61J 15/00

(52) U.S. Cl. CPC A61J 15/0049; A61J 15/0003; A61J 15/0069; A61J 15/0073

(57) ABSTRACT

A nasogastric (NG) tube for placement into the lumen of the stomach by way of a nostril having a tapered tip, a lubricious coating, and one or more expandable balloons that surround drainage ports. During insertion into the stomach the tapered tip and lubricious coating facilitate the tube traversing the patient's nasopharynx and esophagus with reduced injury. During insertion the expandable balloons are maintained in a low profile state but upon reaching the stomach lumen are expanded to a high profile state and improve drainage by pushing the stomach wall away from the drainage ports.

### CROSS-REFERENCE TO RELATED APPLICATION:

This application claims priority to PCT Application number PCT/US13/055554 filed on Aug. 19, 2013 and U.S. provisional application No. 61/684,363 filed Aug. 17, 2012 the contents of which are hereby incorporated by reference.

### FIELD OF THE INVENTION

The present invention is in the field of medical devices and pertains to nasogastric tubes which are tubes used for a process of introducing material to or removing material from the gastrointestinal tract by means of a flexible tube inserted through the nasal passages or mouth.

### BACKGROUND

The Levin nasogastric tube is the most widely used nasogastric tube today. It consists of a long, flexible, single lumen tube, with evacuated drainage ports at one end used for removing stomach contents. The medical industry uses millions of nasogastric tubes every year for a variety of purposes including: removal of air and fluid from the stomach and gasto-intestinal tract, diagnosis of gastrointestinal disease, to treat blockage or obstruction, for irrigation or alternately to deliver substances like medication and nutrition. Tubes used primarily for feeding are generally smaller and softer than nasogastric tubes and considered to be a distinct class of medical device. Despite the ubiquity of nasogastric tubes, they are plagued by several major problems including injuries during placement, misplacement and the need for frequent verification of placement, and poor drainage and clogging.

Injury during placement results because there still is no reliable and safe technique for placing nasogastric tubes. Most nasogastric tubes are placed blindly by clinicians who can rely upon only experience and anatomical knowledge. In conscious patients, passage of the NG tube over the nasopharynx provokes the gag reflex and may cause patients to cough or convulse. Injuries include trauma to the nasal passage, punctures of the submucose, extensive bleeding, perforations of the neck, spine and brain. The most common injury results from passage through the nasopharnyx which has a sharp curve at the back of the nasal cavity. Scraping of the wall of the pharynx by the nasogastric tube frequently produces bleeding.

Misplacement results when clinicians inadvertently miss the esophagus and instead insert the nasogastric tube into the trachea or even further into the bronchi of the lungs. Misplacements can also occur in the spine and brain. This is a dangerous situation for patients and if suction is turned on or fluids delivered through the nasogastric tube injury may result. In order to avoid severe injury to patients verification must be made using a stethoscope to listen for air injected into the stomach and by testing the pH of stomach fluid. Placement must be re-verified regularly since movement by the patient may change its location. In addition, placement must be re-verified anytime the tube is used to deliver rather than remove substances from the stomach.

Poor drainage and clogging results when all the solids and fluids are removed from the stomach lumen and the remaining air is evacuated by the drainage ports. At this point atmospheric pressure exceeds stomach pressure and the stomach lumen will tend to collapse upon the vacuum source at the drainage ports. This can cause serious injury to the patient such as bleeding ulcerations and prevents further draining.

Several variations of nasogastric tubes have been disclosed that sought to reduce the nasopharyngeal injuries and misplacement. Stiffer nasogastric tubes have pre-formed curves that can be more anatomically conforming and make them easier to place, but also have a greater tendency to damage tissue. One modification disposes a rigid, curved sheath upon the outside of the nasogastric tube and the sheath facilitates traversal of nasopharynx but is then removed. Softer nasogastric tubes are easier on the patient but harder to place correctly. They can be disposed with a stiffer distal tip using a stylet, or wire that is removed after placement. They can also be disposed with a deformable distal tip for maximum patient comfort. Weighting the distal tip is helpful in negotiating the esophogous/trachea branch point. Lubrication as well as various handles and measuring lines are also previously disclosed features.

A modification of the Levin nasogastric tube that is now widely used is the dual lumen Salem Sump nasogastric tube. It sought to address the problem of poor drainage by adding a smaller secondary vent lumen, also known as a pigtail, to the primary suction lumen. The secondary vent lumen allows air to be drawn from outside and delivered to the stomach while the vacuum is turned on so that stomach pressure does not fall so far below atmospheric pressure that the stomach is caused to collapse upon the drainage ports. Unfortunately even with Salem Sump nasogastric tubes poor drainage, blockages and resulting gastric ulcers are still common. In addition the secondary vent lumen is prone to reflux and backward flow of stomach contents which had to be addressed by placing a one directional air valve atop the vent lumen to maintain pressure when the suction lumen is not active.

U.S. Pat. No. 7,972,324 issued to Quint discloses a catheter with a soft catheter tip and a jointed attachment to the catheter shaft. Also disclosed is a balloon located proximal to the drainage ports.

U.S. Pat. No. 5,643,230 issued to Linder discloses a nasogastric suction catheter utilizing a dual lumen and having a short, soft, hollow, distal end that has a drainage member where drainage ports are embedded within longitudinal ridges.

U.S. Pat. No. 5,788,680 issued to Linder discloses another dual-lumen suction catheter with multiple apertures in the vent lumen.

U.S. Pat. No. 5,560,747 issued to McCue discloses a multi-lumen nasogastric tube with a pH monitor and anchor assembly.

U.S. Pat. No. 4,834,724 issued to Geiss discloses a nasogastric tube with a convolved, helical portion about a central axis with at least one aspirating port located within the area obscured by the helical portion. Essentially, the helix holds the stomach wall away from the drainage port.

U.S. Pat. No. 4,821,715 issued to Klingenstein discloses nasogastric tube with a flexible tip which buckles, collapses upon contact with patient body. Tip geometries include cylindrical, frustconical, tapered, bulbous, pleated, necked. The tip may be hollow or solid, symmetrical or asymmetrical. The tube body may have zones of different stiffness.

U.S. Pat. No. 5,078,701 issued to Grassi discloses a wire guided intestinal catheter.

U.S. Pat. No. 7,918,841 issued to Sinha discloses-devices and methods for nasoenteric intubation. Flared proximal end, beveled distal end. Two curves.

U.S. Pat. No. 7,604,627 issued to Kojouri discloses a nasopharyngeal sheath for nasogastric intubation. System comprises a nasogastric tube and a curved rubber nasopharyngeal sheath long enough to reach the hypopharynx from nostrils. Provides an easy to insert guide device through which the nasogastric tube can be passed without injuring the patient. Once placed, the sheath is withdrawn and separates along its long axis from removal from the tube.

U.S. Pat. No. 5,690,620 issued to Knott discloses an anatomically conforming nasogastric tube with normally curved tip and method for using same.

U.S. Pat. No. 5,417,664 issued to Felix discloses a double lumen nasogastric tube with a hydrophobic filter at the proximal end of a sump lumen to act as a reflux inhibitor.

U.S. Pat. No. 4,887,997 issued to Okada discloses a catheter for nasogastric intubation.

U.S. Pat. No. 3,114,373 issued to Andersen discloses a gastrointestinal sump tube assembly for a dual lumen NG tube.

U.S. Pat. Reexam No. 40,913 issued to Schweikert discloses a multi-lumen catheter assembly and methods for making and inserting the same.

U.S. Pat. No. 7,921,847 issued to Totz discloses a device and method for placing within a patient an orogastric enteral tube after endotracheal intubation via the mouth.

U.S. Pat. No. 5,334,167 issued to Cocanower discloses a modified nasogastric tube for use in enteral feeding. A nasogastric tube with a collapsible, tear off sheath on the outside which can be used to guide placement of a feeding tube. The sheath is impregnated on the internal surface with water activated lubricant which allows for placement of the feeding tube through the sheath. Reduces the risk of malplacement, eliminates the need for x-ray verification of feeding tube placement, reduces patient discomfort.

U.S. Pat. No. 4,821,715 issued to Downing discloses a nasopharyngeal air tube of predetermined length (stops at the oropharynx) with two lumens embedded in the wall that both carry oxygen.

U.S. Pat. No. 5,592,506 issued to Linder discloses a transnasal conduit for the atraumatic introduction of probes and diagnostic equipment, especially the transesophageal echocardiograph (TEE) sensors (better than ECG, PAC, TEE can be used when the chest is open).

U.S. Pat. No. 6,589,208 issued to Ewers discloses a self-deploying catheter assembly. The drainage ports are located inside of the balloon which is also permeable.

U.S. Pat. No. 7,264,859 issued to Rouns discloses a lubricious coating for medical devices. Cites the use of hydrogel polymer, quaternary amine acrylate polymer.

U.S. Pat. No. 7,766,899 issued to Bolmsjo discloses an indwelling prostatic urethral, urinary catheter. These and all other referenced patents are incorporated herein by reference in their entirety. Furthermore, where a definition or use of a term in a reference, which is an incorporated reference here, is inconsistent or contrary to the definition of that term provided herein applies and the definition of that term in the reference does not apply.

### SUMMARY OF THE INVENTION

In view of the shortcomings of the prior art, it is the object of this invention to provide an improved nasogastric tube that can be passed through the nasopharynx and the esophagus with reduced injury and placed in the stomach with great reliability.

Another object of the present invention is to provide an improved nasogastric tube that provides effective drainage from the stomach without causing gastric ulcers.

Further objects and advantages of the invention will become apparent to those skilled in the art upon reading and consideration of the following description of a preferred embodiment and the accompanying drawings.

### BRIEF DESCRIPTION OF THE DRAWINGS

FIG. 1 shows a preferred embodiment of a nasogastric tube where the distal tip is blunt according to the invention.

FIG. 2 shows a preferred embodiment of a nasogastric tube where the outside surface of the tube is disposed with a lubricious coating according to the invention.

FIG. 3 shows a preferred embodiment of a nasogastric tube where the distal tip is tapered according to the invention.

FIG. 4 shows a preferred embodiment of a nasogastric tube where a balloon spacer, shown in a high profile state, is disposed proximal to the drainage ports according to the invention.

FIG. 5 shows a preferred embodiment of a nasogastric tube where the drainage ports are intercalated with the balloon spacers according to the invention.

FIG. 6 shows a preferred embodiment of a nasogastric tube where a conduit tube supplies pressure to expand and contract balloon spacer profiles according to the invention.

FIG. 7 shows preferred embodiments of a multilumen nasogstric tube where conduit tube(s) are disposed in various configurations according to the invention.

FIG. 8 illustrates a preferred method according to the invention.

### DETAILED DESCRIPTION OF THE EMBODIMENTS

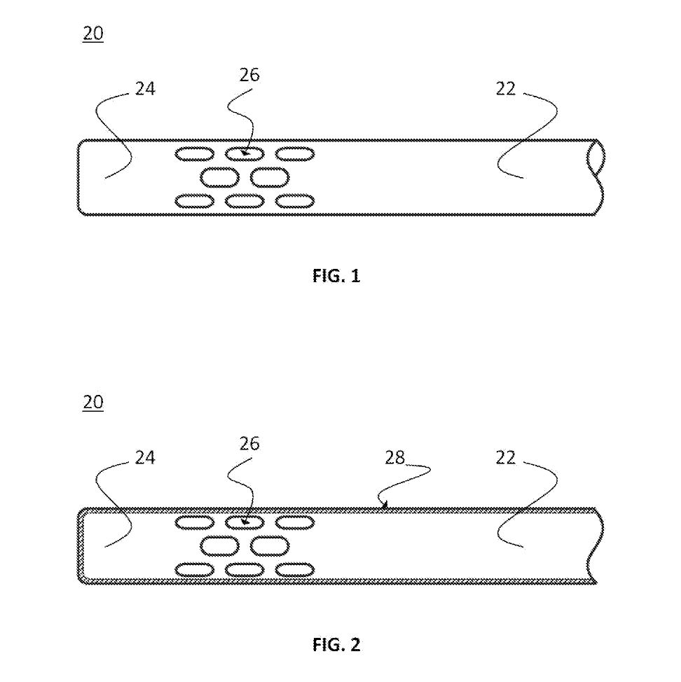

Referring now to the drawings wherein the showings are for purposes of illustrating a preferred embodiment of the present invention and not for purposes of limiting the same. A first embodiment of the invention is a nasogastric tube illustrated in FIG. 1, an nasogastric tube 20, where the tube is clear, flexible, hollow and is made from latex, silicone, nylon, polyurethane or polyvinyl chloride. Nasogastric tube 20 is between 75-100 cm in length and between 8-18 French in diameter. Nasogastric tube 20 has two ends, proximal 22, which remains outside the patient and distal 24, which is placed in the patient's stomach. The proximal end 22 is disposed with an attachment for a suction or syringe. The distal end 24 is disposed with a blunt tip, and further has ports for evacuated drainage 26, which may extend around the entire circumference of the tube and along the distal most 5-10 cm of the tube. Nasogastric tube 20 may be further disposed with a hydrophilic coating 28 illustrated in FIG. 2 which is both lubricious and smooth to aid the clinician in placing the device.

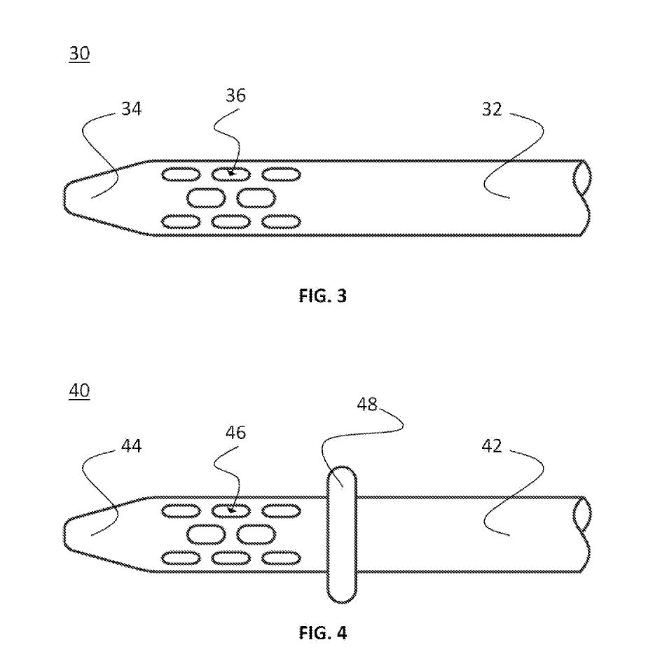

A second embodiment of the invention is a nasogastric tube 30 illustrated in FIG. 3, nasogastric tube 30, with a proximal end 32, evacuated drain ports 36, and a distal end 34 disposed with tapering, or a progressive reduction in the diameter of the tube over the distal most 0.5-10 cm of tube with the distal most point being formed in rounded end. The reduction in tube diameter may be symmetrical with respect to opposite edges of the tube opening so that the tube end point is located in the center of the tube opening. Alternately the reduction in tube diameter may be asymmetrical so that the end point of the tube is located closer to one side of the tube opening than the other. The tapered tip is soft and can be made from latex, silicone, nylon, polyurethane, or polyvinyl chloride and may be further coated in Teflon or other lubricious materials.

A third embodiment of the invention is a nasogastric tube 40 illustrated in FIG. 4, an nasogastric tube 40, with a proximal end 42, evacuated drain ports 46, a distal end 44 and where an expandable balloon spacer 48 is disposed proximal to the drainage ports 46. At each position where a balloon spacer is located, there may be one or more balloons. When the balloons are inflated to the high profile state they exclude stomach tissue from a volume that covers several centimeters surrounding the drainage ports. Balloons are disposed upon the tube by extrusion as a single piece with the tube. Balloons may also be disposed upon the tube by adhesive or UV crosslinking. The balloons are made of materials capable of withstanding the low pH and enzymatic environment of the stomach including latex, silicone, nylon, polyurethane, or polyvinylchloride. The balloons may be compliant, semi compliant, or non compliant, with a preferred inflation pressure between 1.0-30 pounds per square inch. Alternatively, high pressure nylon balloons can withstand pressures of 150-300 pounds per square inch.

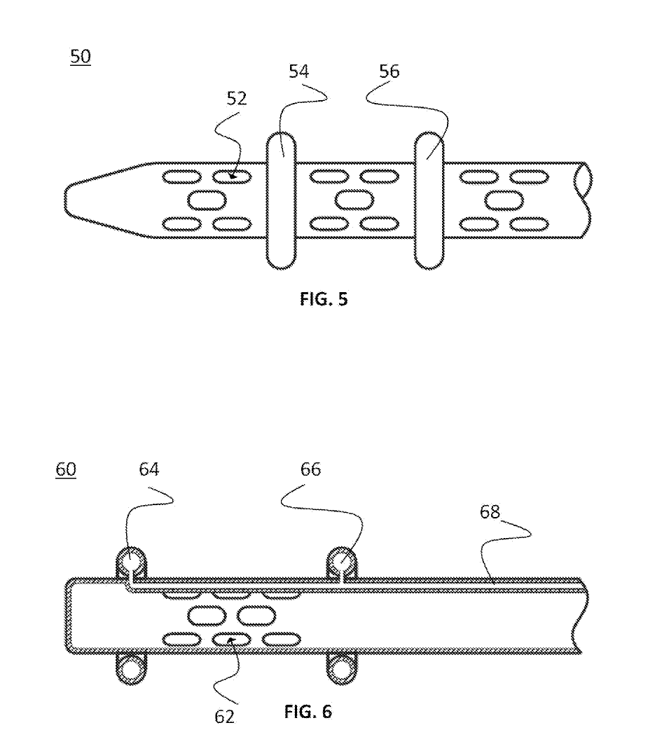

A fourth embodiment of the invention is a nasogastric tube 50 illustrated in FIG. 5, nasogastric tube 50, which has similar structure to nasogastric tube 40 but where the drainage ports 52 are intercalated within the expandable balloon spacers 54 and 56. Balloons are not intended to be limited in shape, several shapes including spherical or oblong shaped balloons would serve a purpose to push the stomach wall away from the nasogatric tube for a clear path to drainage holes on the nasogastric tube.

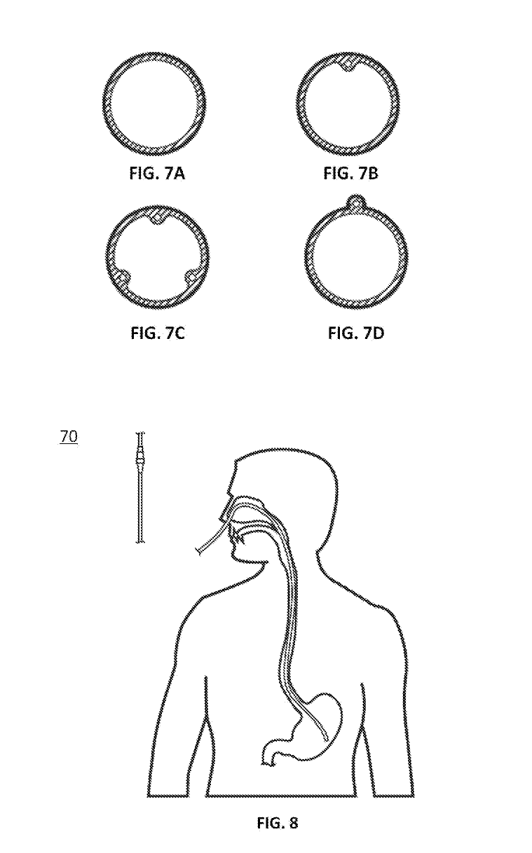

A fifth embodiment of the invention is a nasogastric tube 60 illustrated in FIG. 6, shows a cross section of nasogastric tube 60, that includes balloon spacers 64 and 66 that are located proximal and distal to the drainage ports. In other embodiments the balloon spacers may be located only distal to the drainage ports. The balloon spacers 64 and 66 may be expanded or contracted by way of a conduit tube 68 that forms a second lumen within nasogastric tube 60. The conduit tube 68 is between 1-2 French in diameter, is capable of withstanding 1.0-30 pounds per square inch of pressure and may carry fluid or gas. In other embodiments illustrated in FIG. 7, the conduit tube may be embedded within the inner wall of the nasogastric tube tube, FIG. 7B, it may also be affixed to the outer wall of the nasogastric tube tube, FIG. 7D. In still further embodiments there may be several conduit tubes identical to the first, FIG. 7C, embedded within the inner wall of the nasogastric tube tube. One or more of these additional conduit tubes may be pressurized up to 300 pounds per square inch to prevent kinking of the nasogastric tube tube during or after placement.

Another embodiment of the invention, illustrated in FIG. 8, provides a method for placing a nasogastric tube in a conscious or unconscious patient 70. First the placement procedure is explained to the patient. Second the nasogastric tube is used to measure from the tip of the nose to the ear lobe and then from the earlobe to halfway between sternum and navel, known as the xyphoid process. This point on the nasogastric tube is marked with tape to mark the approximate length of tube needed to reach the stomach. Third, the distal tip of the nasogastric tube is bent into a gradual curve of approximately 45 degrees. Then lubrication is applied to the surface of the nasogastric tube. The distal end of the nasogastric tube is inserted into a patient's nostril. The distal end is advanced 3-4 inches into the posterior nasopharynx. At this point the conscious patient will begin to gag. Next the patient is asked to tilt the head forward, take a drink of water and swallow. The operator asks the patient to repeat drinking and swallowing for the rest of the procedure. If resistance is met during insertion the tube may be rotated slowly. Then the operator directs the nasogastric tube down into the esophagus taking care to avoid the trachea until the distal end reaches the desired internal point in the stomach. Then the tube is taped to the patient's nose. An operator can verify placement of the nasogastric tube by injecting a bolus of air and listening with the stethoscope at the end of the xyphoid process. An operator confirms localization by withdrawing stomach contents and testing pH. Inflate balloon spacers to a high profile state. Turn on the vacuum. When finished or when the tube needs replacing the balloons are deflated to a low profile state and the device is withdrawn.

Additional modifications and improvements of the present invention may also be apparent to those skilled in the art. Thus, the particular combination of parts described and illustrated herein in intended to represent only one embodiment of the invention, and is not intended to serve as limitations of alternative devices within the spirit and scope of the invention.

What is claimed:

1. An improved nasogastric tube comprised of aspirating holes surrounded by inflatable balloon spacers and disposed with a lubricious coating.

2. The nasogastric tube of claim 1 wherein the tube is produced from materials chosen from the group consisting of latex, silicone, nylon, polyurethane, and polyvinyl chloride.

3. The nasogastric tube of claim 1 wherein a single inflatable balloon is used at each balloon spacer location.

4. The nasogastric tube of claim 1 wherein an array of balloons is used at each balloon spacer location.

5. The nasogastric tube of claim 1 wherein the balloons used can be inflated by air pressure.

6. The nasogastric tube of claim 1 where in the balloons used can be inflated by fluid pressure.

7. The nasogastric tube of claim 1 wherein the balloon spacers are located proximal to the aspirating holes.

8. The nasogastric tube of claim 1 wherein the balloon spacers are located distal to the aspirating holes.

9. The nasogastric tube of claim 1 wherein the balloon spacers are located distal and proximal to the aspirating holes.

10. The nasogastric tube of claim 1 wherein the balloon spacers are intercalated among the aspirating holes.

11. The nasogastric tube of claim 1 wherein the balloon spacers inflate to exclude a space equivalent to a spherical area that covers several centimeters surrounding the drainage ports.

12. The nasogastric tube of claim 1 wherein the balloons are chosen from the group consisting of compliant, semicompliant and non compliant balloons.

13. The nasogastric tube of claim 1 wherein the balloon spacers are produced from materials chosen from the group consisting of latex, silicone, nylon, polyurethane, and polyvinyl chloride.

14. The nasogastric tube of claim 1 wherein a conduit tube forms a second lumen within the main tube and is pressured to 20 atm to prevent kinking of the main tube.

15. The nasogastric tube of claim 1 wherein the distal end is disposed with a tapered tip over the distal most 0.5-10 cm and where the reduction in tube diameter may be symmetrical with respect to opposite edges of the tube opening so that the tube end point is located in the center of the tube opening.

16. The nasogastric tube of claim 1 wherein the distal end is disposed with a tapered tip over the distal most 0.5-10 cm and where the reduction in tube diameter may be asymmetrical so that the end point of the tube is located closer to one side of the tube opening than the other.

17. The nasogastric tube of claim 1 wherein the distal end is disposed with a tapered tip produced from materials chosen from the group consisting of latex, silicone, nylon, polyurethane and polyvinyl chloride.

18. A method for introducing an improved nasogastric tube into a patient comprising the steps of
a) explain procedure to patient
b) measure from tip of nose to earl lobe, then from earlobe to halfway between sternum and navel, xyphoid process
c) mark with tape
d) bend the distal tip into a gradual curve
e) lubricate the surface of the nasogastric tube
f) inserting the distal tapered end of the lubricated tube into a patient's nostril
g) advancing said distal tapered end of said lubricated tube 3-4 in to the hypopharynx
h) patient will begin to gag. Ask the patient to tilt the head forward
i) ask the patient to take a drink of water and swallow
j) ask the patient to repeat
k) if resistance is met rotate the tube slowly
l) directing said nasogastric tube down downwards into the esophagus and then to the desired internal point in the stomach
m) tape the tube to patients nose
n) verifying placement of said nasogastric tube by injection a bolus of air and listening with the stethoscope
o) verify placement by withdrawing stomach contents and test pH
p) inflating balloon spacers to the high profile state
q) turn on the vacuum.

19. The method of making a nasogastric tube comprising the following
